(19) United States
(12) Patent Application Publication
(10) Pub. No.: US 2026/0362108 A1
(43) Pub. Date: Nov. 12, 2026

(54) MECHANISM TO PROVIDE TIMELY NETWORK ASSISTANCE TO THE UE IN A DISASTER SITUATION

(71) Applicant: Nokia Technologies Oy, Espoo (FI)

(72) Inventors: Gagandeep BHATTI, Dallas, TX (US); Shohreh AHVAR, Massy (FR); Daniela LASELVA; Laurent GOIX, Massy (FR); Ehsan AHVAR, Massy (FR)

(21) Appl. No.: 19/203,477

(22) Filed: May 9, 2025

(51) Int. Cl. H04W 4/90; H04W 36/00; H04W 36/36; H04W 48/20; H04W 76/20

(52) U.S. Cl. CPC H04W 4/90; H04W 36/0058; H04W 36/362; H04W 48/20; H04W 76/20

(57) ABSTRACT

A user equipment (UE) receives a potential disaster message indicating potential occurrence of a disaster. Potential disaster information indicates: a risk type and predicted time of potential occurrence of the disaster; a risk of physical disruption to physical cells; recommended association information for different association transition types; and preferred physical cells. The UE may preconfigure UE actions based on this information. The UE may then receive an imminent disaster message indicating imminent occurrence of the disaster. The UE may then determine a selected UE action based on a current UE state, the associated physical cell of the UE, and perform the selected UE action. The UE optionally generates a UE actions index indexing UE action types by UE states, risk types, and risk scores. When a combination of these indicates a plurality of alternative UE action types, the UE may select amongst them based on UE criteria.

### TECHNICAL FIELD

The present disclosure generally relates to communication networks. More specifically, the present disclosure relates to a method, apparatus, system and computer program for a radio access network (RAN) node to enable user equipment (UE) in a communication network to preconfigure disaster response actions before the occurrence of physically disruptive disaster conditions.

### BACKGROUND

A mobile telecommunication network or cellular network (generally referred to herein as a communication network) enables communications between two or more communication devices, provides communication devices access to a data network, delivers services provided by third-party applications to communication devices, or provides services offered by the communication network to communication devices.

A communication network and communication devices may operate in accordance with cellular technologies (otherwise referred to as radio access technologies), such as GSM, UTMS, LTE, LTE-A, and NR. Cellular technologies are standardized by various standards organization, such as the Third Generation Partnership Project (3GPP) or ETSI (European Telecommunications Standards Institute). 3GPP is currently developing standards for 5th generation cellular technologies (generally referred to a 5G or NR standards) and 6th generation cellular technologies (generally referred to a 6G standards). Communication networks that operate in accordance with 5G or NR standards are generally referred to as 5G networks and communication networks that operate in accordance with 6G standards are generally referred to as 6G networks.

A communication network (e.g., a 5G network or a 6G network) includes access networks (e.g., radio access networks) that can communicate wirelessly with one or multiple communication devices by sharing available resources (e.g., bandwidth, transmit power, etc.) of the access network (e.g., radio access network). A communication network can also establish reliable, secure connectivity between communication devices and a core network of the communication network via access networks. A communication network (e.g., a 5G network) may provide enhanced mobile broadband services (e.g., telephony, video, data, short message services), ultra-reliable low-latency communication services (e.g., XR services), or massive machine type communication services to communication devices.

Improvements to communication networks are desirable.

### SUMMARY

According to some aspects, there is provided the subject-matter of the independent claims. Some further aspects are defined in the dependent claims.

### BRIEF DESCRIPTION OF THE DRAWINGS

Reference will now be made, by way of example, to the accompanying drawings which show example implementations of the present application, and in which:

FIG. 1 is a schematic block diagram illustrating a user equipment, a communication network, and a data network in accordance with an example implementation.

FIG. 2 is a schematic block diagram illustrating user equipment and RAN nodes of a radio access network nodes in accordance with an example implementation.

FIG. 3 is a schematic diagram illustrating physical and logical components of an apparatus for the communication network of FIG. 1 in accordance with an example implementation.

FIG. 4 is a schematic diagram illustrating physical and logical components of a user equipment in accordance with an example implementation.

FIG. 5 is a timing diagram of a method of a UE and an access network of a communication system in accordance with example implementation.

FIG. 6 is a corresponding flowchart of a method of the UE, and

FIG. 7 is a corresponding flowchart of a method of an associated RAN node of the communication system.

FIG. 8 is a timing diagram of a method of a UE performing a condition handover to a neighbour RAN node, in accordance with an example implementation.

FIG. 9 is a timing diagram of a method of a UE performing a cell reselection to a neighbour RAN node, in accordance with an example implementation.

Similar reference numerals may have been used in different figures to denote similar components. Unless otherwise specifically noted, articles depicted in the drawings are not necessarily drawn to scale.

### DESCRIPTION

### Overview

The present disclosure relates to improving the continuity and efficiency of wireless communications in mobile networks in disaster conditions. In particular, the embodiments disclosed herein provide for the advanced configuration of UEs when a disaster condition having the potential to disrupt physical cells is predictable. UE reassociation to another physical cell or access point less disrupted by the disaster condition may be thus facilitated. In this way, greater continuity and efficiency of wireless communications in the mobile network may be achieved.

In general, various different aspects or parts of the infrastructure and equipment of a wireless network may be more or less vulnerable to different types of disaster. In particular, different physical cells may have different such vulnerabilities. The term “physical cell” as used herein includes a radio cell (or simply “cell”) in a mobile network identified by a unique physical cell ID. A physical cell is provided by a Radio Access Network (RAN) node controlling a radio equipment set, which typically includes a radio unit and an antenna. A RAN node may control the radio equipment set to provide a single physical cell, or to provide multiple physical cells. In such case, the multiple physical cells may provide cells in correspondingly different sectors, on correspondingly different carrier frequencies, or using correspondingly different radio access technologies, among other possibilities. Thus, the ability of different physical cells to provide reliable and efficient wireless connectivity to UEs may involve different risks to disruption by a given disaster based on the different vulnerabilities the physical cells have to the disaster type. For example, a first radio equipment set may be provided on the roof of a building, while a second radio equipment set may be provided in a basement of the same building, where each is controlled by a different RAN node, or both are controlled by the same RAN node. The first radio equipment set, and thus the physical cells it is operated to provide, may be vulnerable to a first type of disaster condition—high winds, for example—but immune to a second type of disaster condition—flooding, for example, while the reverse may be the case for the second radio equipment set, and thus the physical cells it is operated to provide.

3GPP standards incorporate mechanisms for rapid network recovery and continuity during emergencies, such as natural disasters or large-scale outages. For example, disaster roaming and MINT (Minimization of service interruption) is defined in Section 4.4.3.3.1 and Section 3.10 of 3GPP TS 23.122. A cell can provide/broadcast a configuration for disaster roaming, including information including the public land mobile networks PLMNs that the UE is allowed to use in case of disaster. The disaster roaming service is activated for the UE upon the UE sending a non-access stratum (NAS) registration request message to the AMF for disaster roaming after losing coverage of the disaster network and upon finding a network that advertises disaster roaming is activated. The access and mobility function (AMF) controls the UE eligibility to the service and may provide the disaster roaming service indication to authentication server function (AUSF) and unified data management (UDM). When the disaster condition is no longer applicable, the disaster roaming PLMN causes the UE to perform PLMN re-selection to go back to normal operation.

In addition, 3GPP has defined Public Warning System (PWS) messages designed to deliver emergency alerts to users in a specific geographic area. PWS includes systems like the Earthquake and Tsunami Warning System (ETWS) and the Commercial Mobile Alert System (CMAS). PWS messages contain information about the emergency, such as the type of event, the affected area, instructions for safety, and any other relevant details. The messages are typically short and concise to ensure quick delivery and easy comprehension. They may include text, symbols, or other formats depending on the capabilities of the network and devices. PWS messages are broadcast using the Cell Broadcast Service (CBS), which allows messages to be sent to all devices within a specific geographic area simultaneously. This ensures that the message reaches a large number of users quickly. ETWS is specifically designed for rapid dissemination of warnings related to earthquakes and tsunamis. CMAS, also known as Wireless Emergency Alerts (WEA) in the United States, is a broader system that covers various types of emergency alerts, including natural disasters, severe weather, missing child alerts (AMBER alerts), and other public safety messages.

The above-described previous methods, however, do not, or do not optimally, provide for proactive mobile network reconfiguration when the disaster condition is at least somewhat predictable, and which may represent different risks of disruption for different neighbouring physical cells. Such disaster conditions may include environmental disaster conditions such as tornado, wildfire (or other fire), flood, and so forth. Such disaster conditions can often be predicted by advanced weather forecasting or other methods, or may be generally observable or predictable in a given geographical area.

The embodiments disclosed herein may enable a network, including particularly one or more RAN nodes, and one or more UEs to proactively reconfigure the UEs based on such disaster condition prediction information, and thus provide for wireless reconfiguration to be performed proactively in order to optimize wireless communication continuity and efficiency when the disaster condition occurs.

In particular, in some embodiments, a part of a network, which may include a part of any one of a data network, a core network, or a radio access network, may receive or be provided with information which enables the determination of a potential risk of occurrence of one or more disasters in a geographical area within a certain timeframe. This information may then be used to generate configuration information which is broadcast to associated UEs in the geographical area in advance of the occurrence of the disaster. In particular, the configuration information may enable UEs associated with physical cells at a relatively higher risk of disruption by the occurrence of the disaster to reassociate in advance to other physical cells or to connect to an alternative access point (e.g. a WiFi access point) having a relatively lower risk of disruption. If it becomes the case that the risk of occurrence of the disaster condition becomes sufficiently high (based on some predefined threshold, for example), and the disaster is imminent, a warning message may be broadcast to the UEs in the geographical area, and the warning message may include updated risk information for the physical cells in the area. Since the configuration information was previously broadcast to the UEs, the warning message may be relatively smaller, and thus the broadcast of the warning message may provide for relatively greater energy efficiency and relatively lower network congestion. Each UE, based on the previously provided information, may then reassociate to a physical cell or access point having relatively lower risk of disruption from the imminent disaster condition. In this way, greater continuity and efficiency of wireless communications in the mobile network may be achieved.

### Systems and Components

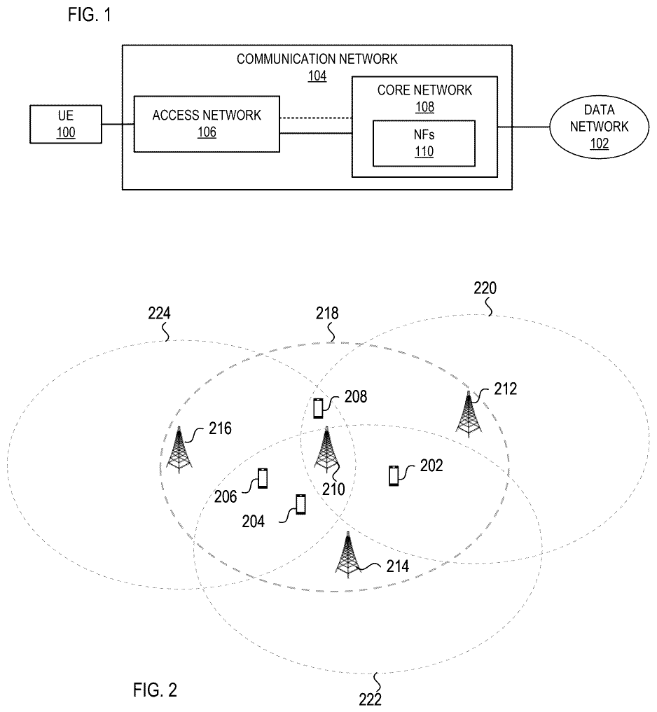

Referring to FIG. 1, an example of a user equipment (UE) 100 that is configured to communicate with a data network 102 via a communication network 104 is shown. The communication network 104 includes an access network 106 and a core network 108 that includes one or more network functions 110. In the present disclosure, the UE 100 and the communication network 104, and, in some implementations, the data network 102 as well, may be referred to, collectively, as a communication system.

The access network 106 provides wireless connectivity (e.g., radio connectivity) to the UE 100 and connects the UE 100 to the core network 104 via a backhaul network. The access network 106 may comprise a Radio Access Network (RAN), a non-terrestrial network (e.g., a satellite network), a wireless local area network (WLAN) or any other type of network that provides wireless connectivity to the UE 100 and connects the UE 100 to the core network 108. The access network 106 provides wireless connectivity (e.g., radio connectivity) to the UE 100 via at least one access node of the access network 106. For example, an access node of the access network 106 may be a radio access node and may provide radio connectivity to the UE 100. A radio access node may comprise a gNodeB (gNB), an ng-eNodeB (ng-eNB)), or an eNodeB (eNB). The access node of the access network 106 may be an access point, such as a Wireless Local Area Network (WLAN) access point and may provide wireless connectivity to the UE 100. In some implementations, the access node of the access network 106 may be an access point that provides wired connectivity to the UE 100 (generally referred to as fixed access). The backhaul network between the access network 106 and the core network 108 may comprise a fixed network, a satellite network, or a combination thereof. The core network 108 connects the access network 106 with a data network (DN) 102 via an interface of the core network 108.

As noted above, the core network comprises network functions (NF) 110 (generally referred to a network function 110 and collectively referred to as network functions 110). Each respective network function 110 may be implemented as a software running on dedicated hardware (e.g., one or more physical computing devices, such as servers), as a virtualized network function (VNF) instantiated using network function virtualization software implemented on a physical computing device, or as a container provided by infrastructure of a cloud computing system. Data network 102 may be an external public network, a private data network, or an intra-operator data network (e.g., for providing IP Multimedia Subsystem (IMS) services).

Each NF 110 of the core network 108 may provide one or more services to other network functions 110 of the core network 108 via a service-based interface (SBI). Each service-based interface (SBI) enables communication between two NFs 110. A SBI is the communication mechanism between these NFs. A SBI uses web-based protocols and principles, primarily HTTP/2 and RESTful Application Programming Interfaces (APIs)+, to facilitate communication between NFs. Each NF 110 can also register itself and the services it supports (e.g., the services it offers other network functions) to a network repository function (NRF) of the core network 108. The NRF may be used by any network function 110 to discover other network functions 110 (or instances of NFs 110) and the services the other NFs 110 support (e.g., services the other NFs provide). Any NF 110 may consume (e.g., use) the services provided and exposed by another NF 110. A NF 110 that consumes a service of another network function is generally referred to as a network function service consumer (NFc). A network function 110 that provides and exposes one or more of its services is referred to as a network function service producer (NFp).

The UE 100 (otherwise referred to herein as a mobile terminal) may be configured to access the access network 106, register with the core network 108, establish one or more data sessions with the core network 108, and access services provided by the core network 108 and/or application functions (not shown) hosted on application servers (not shown) of the data network 102.

The core network 108 may be, for example, a 5G core network (5GC) that operates based on the 5th generation radio access technology described, for example, in the 3rd Generation Partnership Project (3GPP) standard for new radio or a 6G core network (6GC) that operates based on a 6th generation radio access technology. The core network 108 includes network functions (generally referred to a network function 110 and collective referred to as network functions 110) may be connected to a management system (not shown) configured to manage the communication network 104. Examples of network functions 110 of the core network 108 include a network function for mobility management, such as mobility management network function (MM NF) or an access and mobility function (AMF), a network function for session management, such as session management network function (SM NF) or a session management function (SMF), a network function for authentication server function (AUSF), a network exposure function (NEF) for providing access to and authorization of untrusted network functions to the core network 108, a network repository function (NRF), a network function for policy control, such as a policy control network function (PC NF) or a policy control function (PCF).

Access network 106, when it is a radio access network, comprises one or more radio access network (RAN) nodes (otherwise referred to as base stations). A RAN node may provide one or more cells. A cell may be, for example, a macro cell, a micro cell, femto, or a pico cell. A cell defines a coverage area or a service area of a RAN node. A RAN node may be, for example, a node B (NodeB or NB), an evolved NodeB (eNodeB or eNB), a next generation node B (gNB), a Remote Radio Unit (RRU), a remote radio head (RRH), a relay, an Integrated Access and Backhaul (IAB) node, or a low power node. RAN nodes may be deployed in non-terrestrial network (NTN) devices, such as satellites (e.g., low earth orbit (LEO) satellites or geosynchronous earth orbit (GEO) satellites), aircrafts, or drones, where such NTN devices form a non-terrestrial network that includes a ground station. RAN nodes may also be deployed on the ground in which case the RAN nodes may be referred to as terrestrial network device. A RAN comprising terrestrial network devices is generally referred to as a terrestrial network.

A RAN node may have a split architecture where functions of the RAN node (e.g., an eNB or a gNB) are split between various entities. A RAN node that has a split architecture may comprise a radio unit (RU) (otherwise referred to as a remote radio head (RRH)), a centralized unit (CU) and one or more distributed units (DUs). A DU may be connected to a RU via a fronthaul. A DU may be connected to a CU via a midhaul or F1 interface. A CU may be connected to a core network (e.g., core network 108) via a backhaul. In a RAN node with a split architecture, operations of the RAN node may be carried out, by the CU, the DU. One CU may control one or more DUs.

A RU converts radio signals sent to and from an antenna into a digital signal for transmission over packet network, handles the digital front end (DFE) and the lower PHY layer, and includes digital beamforming functionality. A DU is a logical entity (e.g., software) that is hosted and run on a server located near an RU. A CU is a logical entity (e.g., software) that is hosted and run on a server. The CU may be hosted and run on its own server or may be hosted and run on the same server that hosts and runs the DU located near an RU. The DU includes a subset of the functions of a RAN node (e.g., eNB or gNB) depending on the split of functions and the CU includes the other functions of a RAN node that are not in the subset of functions of the DU. A DU may comprise a subset of the layers of a protocol stack of a RAN node and a CU may comprise the other layers of the protocol stack that are not in the subset of layers in the DU. For example, in some implementations, a DU may include a radio link control (RLC) layer, a medium access control (MAC) layer and a physical (PHY) layer of a protocol stack for a RAN node, whereas a CU may comprise the layers of the protocol stack of a RAN node above the RLC layer, such as a packet data convergence protocol (PDCP) layer, a radio resource control (RRC) layer and an internet protocol (IP) layer. The operations of a DU are controlled by a CU.

Referring to FIG. 2, a schematic diagram illustrating four UEs 202, 204, 206, and 208 and four RAN nodes 210, 212, 214, and 216 of a radio access network is shown. The UEs 202, 204, 206, and 208 may be similar to the UE 100 described previously with reference to FIG. 1, and the RAN nodes 210, 212, 214, and 216 may be similar to RAN nodes described in relation to the access network 106 described previously with reference to FIG. 1. In the example shown, each of the RAN nodes 210, 212, 214, and 216 has a respective associated cell 218, 220, 222, 224. In an example in which the UEs 202, 204, 206, and 208 are all connected to RAN node 210 in order to, for example, access for example a data network such as data network 102, via a core network, such as core network 108, the RAN node 210 may be referred to as a “serving RAN node” for the UEs 202, 204, 206, and 208, and the other RAN nodes 212, 214, 216 may be referred to herein as “neighbour RAN nodes”.

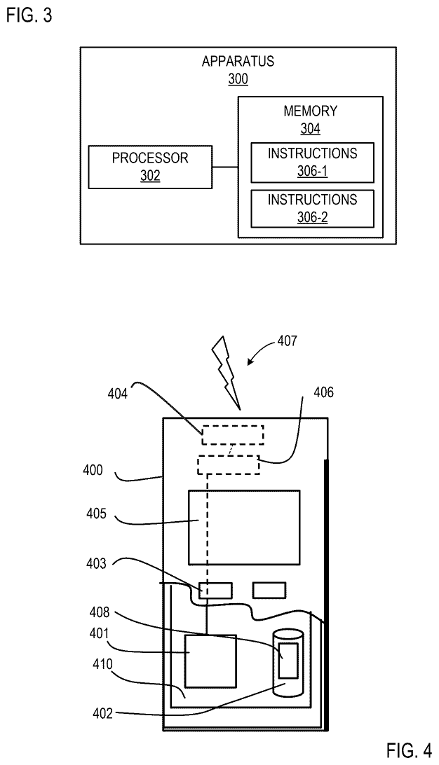

FIG. 3 shows physical and logical components of an exemplary apparatus 300 in accordance with some embodiments of the present disclosure. In some embodiments, one or more of the UE 100, the data network 102, the communication network 104, the access network 106, the core network 108, the UEs 202, 204, 206, 208, and the RAN nodes 210, 212, 214, 216 may be or include one or more respectively corresponding instances of the apparatus 300. Although an example implementation of the apparatus 300 is shown and discussed below, other apparatus may be used to implement embodiments disclosed herein, which may include logical and physical components that are different from those shown in FIG. 3. Also, although FIG. 3 shows a single instance of each logical and/or physical component of the apparatus 600, there may be multiple instances of each logical and/or physical component shown in FIG. 3.

The apparatus 300 includes one or more processors 302, such as a central processing unit (CPU), a microprocessor, an application-specific integrated circuit (ASIC), a field-programmable gate array (FPGA), a dedicated logic circuitry, a graphics processing unit (GPU), a tensor processing unit, a neural processing unit, a dedicated artificial intelligence processing unit, a hardware accelerator, a quantum processor, or any combinations thereof. The one or more processors 302 may generally be referred to as processor 302 and collectively be referred to as processors 302.

The apparatus 300 also includes one or more memories 304 (generally referred to a memory 304 and collectively referred to herein as “memories 304”), which may include volatile or non-volatile memory (e.g., a flash memory, a random-access memory (RAM), and/or a read-only memory (ROM)). Memory 304 may store machine-executable instructions for execution by at least one of the one or more processors 302 to perform the operations of the apparatus 300 as described in the different embodiments disclosed herein. In general, the machine-executable instructions 306 of an apparatus 300 described herein are shown stored in the memory 304, which may be executed by at least one of the one or more processors 302, to cause the apparatus 300 to perform the operations described herein with respect to the embodiment disclosed. The memory 304, in addition to the machine-executable instructions 306 may store data, information, rules, and/or policies.

In some examples, the apparatus 300 may also include one or more electronic storage units (not shown), such as a solid-state drive, a hard disk drive, a magnetic disk drive and/or an optical disk drive. In some examples, one or more datasets and/or modules may be provided by an external memory (e.g., an external drive in wired or wireless communication with the apparatus 300) or may be provided by a transitory or non-transitory computer-readable medium. Examples of non-transitory computer readable media include a RAM, a ROM, an erasable programmable ROM (EPROM), an electrically erasable programmable ROM (EEPROM), a flash memory, a CD-ROM, or other portable memory storage. The storage units and/or external memory may be used in conjunction with memory 304 to implement data storage, retrieval, and caching functions of the apparatus 300.

The processor 302 and memory 304 of the apparatus 300 may communicate with each other via a communication bus, for example. In some implementations, the apparatus 300 is a distributed computing system that includes multiple computing devices (e.g., servers) in communication with each other over a data network, as well as optionally one or more additional components. The various operations described herein may be performed by different computing devices (e.g., servers) of a distributed computing system in some implementations. In some implementations, the apparatus 300 is a virtual machine provided by the infrastructure (e.g., a hypervisor, processors, and memories) of a cloud computing system.

Referring to FIG. 4, an example of user equipment 400, such as the example user 100 described previously with reference to FIG. 1, is shown. Although FIG. 4 shows a single instance of each physical and/or logical component of the user equipment 400, the user equipment 400 may include multiple instances of each physical and/or logical component shown in FIG. 4.

User equipment 400 may be any device capable of sending and receiving radio signals. Non-limiting examples of a user equipment include a mobile station (MS), a mobile device such as a mobile phone or what is known as a ‘smart phone’, a computer provided with a wireless interface card or other wireless interface facility (e.g., USB dongle), a personal data assistant (PDA) or a tablet provided with wireless communication capabilities, a machine-type communications (MTC) device, an Internet of things (IoT) type communication device or any combinations of these.

The user equipment 400 also includes one or more processors 401, one or more memories 402 (collectively referred to as memory 402) and other components or circuitry 403 for use in software and hardware aided execution of operations the user equipment 400 is configured to perform, including control of access to and communications with access networks (e.g., the access network 106 illustrated in FIG. 1). The processor 401 is coupled to the memory 402. The one or more processors 401 may comprise a central processing unit (CPU), a microprocessor, multicore processor, a tensor processing unit (TPU), a graphics processing unit (GPU), a neural processing unit (NPU), a dedicated logic circuit, an application specific integrated circuit, a field programmable gate array (FPGA), a dedicated artificial intelligence processing unit, a hardware accelerator, a quantum processor, or any combinations thereof. The memory 402 may include a volatile or non-volatile memory (e.g., a flash memory, a random-access memory (RAM), and/or a read-only memory (ROM).

The processor 401 may be configured to execute software code 408 (e.g., the processor may execute instructions of the software code 408). The execution of the software code 408 (or the execution of the instructions of the software code) may for example cause the user equipment 400 to perform one or more operations, including the operations described in different embodiments disclosed herein. The software code 408 may be stored in memory 402.

The user equipment 400 also include an antenna array 404 and a transceiver 406 for transmitting wireless signals (e.g., radio signals) to access nodes of an access network (e.g., a radio access network node of a RAN) and/or receiving wireless signals from access nodes of an access network (e.g., a radio access network node of a RAN) over an air interface 407. The wireless signals (e.g., radio signals) may carry communications, such as voice, electronic mail (email), text messages, multimedia data, and/or machine data. The antenna array 404 may be arranged internally or externally to the user equipment 400. The antenna array 404 may comprise one or more antenna elements. The antenna array 404 may be a multi-input multi output (MIMO) antenna.

The processor 401, the at least one memory 402, the transceiver 406 and other components or circuitry 403 of the user equipment 400 (e.g., a modem) can be provided on a circuit board, in chipsets, or in a system on chip (SOC). The circuit board, chipsets or SOC is denoted by reference 410 in FIG. 4. User equipment 400 may optionally include an input device 405, such as a keyboard, a keypad, or a touch-sensitive display device. The input device 405 may comprise a user interface. The user equipment 400 also includes a battery (not shown). The user equipment 400 may also include a speaker (not shown) and a microphone (not shown). The user equipment 400 may also include a universal subscriber identity module (USIM) (not shown) or an embedded subscriber identity module (eSIM) (not shown).

### Configurations and Operations

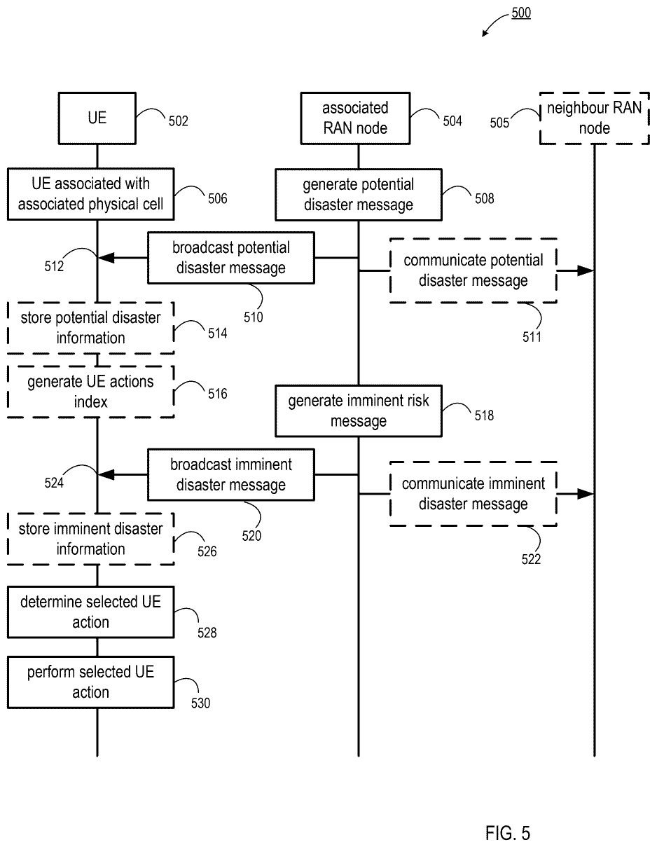

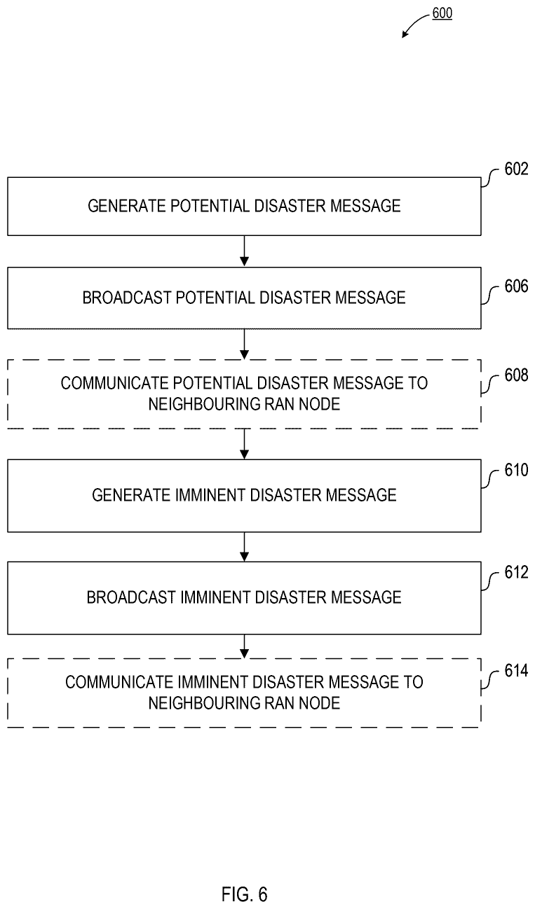

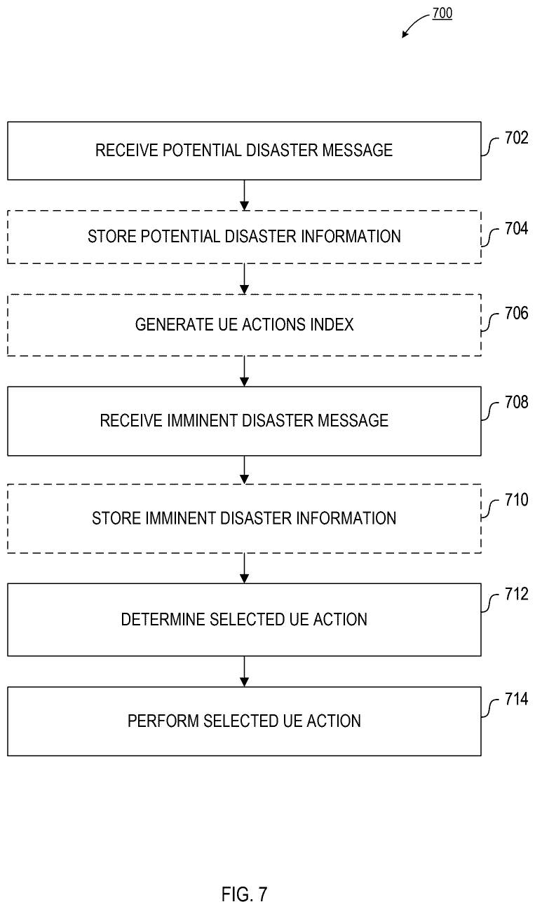

FIG. 5 is a timing diagram of a method 500 in a communication system, involving a UE 502, such as UE 100, and an associated RAN node 504, such as RAN node 210. FIG. 6 is a flowchart of a corresponding method 600 performed by the associated RAN node 504, and FIG. 7 is a flowchart of a corresponding method 700 performed by the UE 502. At 506, the UE may be associated with a particular physical cell, termed here as the associated physical cell, having a corresponding associated physical cell ID. By “associated” it is meant that the UE 502 is configured at least to receive or monitor broadcasts from the associated physical cell. For example, the UE 502 may be connected with the associated physical cell—as in the RRC Connected state—or may be camping on the associated physical cell—as in the RRC Idle or RRC Inactive states. The associated physical cell may be a physical cell controlled by the associated RAN node 504.

At 508 and 602, the associated RAN node 504 may generate a potential disaster message including potential disaster information. The RAN node 504 may generate or obtain the potential disaster information based on information received from any part of the communication network 104 or data network 102 (collectively, the “network”). From any suitable source, the network may obtain information indicating a potential occurrence of a disaster, and may determine portions of the communications network 104, such as one or mode RAN nodes, such as RAN nodes 210,212,214,216, controlling one or more physical cells which may be disrupted by the disaster. On this basis the network may determine the potential disaster information. Non-limiting examples of such information sources include weather prediction information sources (e.g. meteorological organizations) and information characterizing the physical cells in the access network 106 with respect to risk of disruption from the occurrence of the disaster. The latter information may be obtained or provided, for example, by or in the form of risk scores from network operators with respect to different disaster risk types (or equivalently “risk types” or “disaster types”), which may be determined at or around the time of design or installation of the radio equipment sets corresponding to the physical cells. The RAN node 504 may receive or obtain the potential disaster information from the network, or information enabling the RAN node 504 to generate the potential disaster information.

In general, the potential disaster information may include one or more of the following: risk type information indicating a risk type of the disaster; potential disaster time prediction information indicating a predicted time of potential occurrence of the disaster; physical cell risk information indicating for each of one or more physical cells a risk of disruption of service by the physical cell based on the potential occurrence of the disaster; recommended wireless network association information indicating for each of one or more wireless network association transition types—that is, one or more types of association transition between wireless networks (e.g. physical cell changes, or WiFi access point changes)—respectively corresponding recommended physical cells or access points for wireless network association; and preferred physical cells information indicating for each of one or more preferred physical cells a preferred physical cell risk score indicating a risk of disruption of service by the preferred physical cell based on the potential occurrence of the disaster. The potential disaster information may include any further desired information useful to perform the operations described herein. For example, the potential disaster information may include expected network service operability level per service (e.g. voice, data, emergency) at different times in the future, and corresponding confidence levels.

At 508, 604, the associated RAN node 504 may generate a potential disaster message comprising the potential disaster information, and at 510 and 606, may broadcast the potential disaster message, which may be in a geographical area containing the UE 502. Optionally, at 511 and 608, the associated RAN node 504 may also communicate the potential disaster message to a neighbour RAN node 505, such as one or more of RAN nodes 212,214,216. At 512 and 702, the UE 502 may receive the potential disaster message. Optionally, at 514 and 704, the UE 502 may store the potential disaster information, in whole or in part, in any suitable data storage and in any suitable form.

Optionally, at 516 and 706, the UE 502 may then generate a UE actions index based on the potential disaster information and the associated physical cell. The 502 may do so based on predefined rules, which may be provided by an operator of the communication network. The UE actions index may index UE action types by UE states, risk types, and risk scores. For example, the UE actions index may be or include a UE actions table. A non-limiting example of a UE actions table is shown in Table 1, below.

TABLE 1
Example UE Actions Index

| Potential Disaster Information | | RRC Connected | | | RRC Idle | |
|---|---|---|---|---|---|---|
| for Associated Physical Cell | | Conditional | Cell | | Cell | |
| Risk Type | Risk Score | Handover (CHO) | Redirection | Other | Reselection | Other |
| Tornado | 5 - Critical | Yes (P) | Yes | — | Yes | — |
| | 4 - High | Yes | Yes | — | Yes | — |
| | 3 - Medium | Deferred | Deferred | — | Deferred | — |
| | 2 - Low | No | No | — | No | — |
| | 1 - No risk | No | No | — | No | — |
| Flooding | 5 - Critical | Yes | Yes (P) | — | Yes | — |
| | 4 - High | Yes | No | — | yes | — |
| | 3 - Medium | Deferred | Deferred | — | Deferred | — |
| | 2 - Low | No | No | — | No | — |
| | 1 - No risk | No | No | — | No | — |

As noted, the UE 502 may be configured to generate the UE actions index based on the potential disaster information and the associated physical cell. In particular, the UE 502 may be configured to determine the UE actions based on the physical cell risk information indicating corresponding risks of disruption of service by the physical cell based on the potential occurrence of the disaster, and the preferred physical cells information indicating corresponding risks of disruption of the preferred physical cells based on the potential occurrence of the disaster. The UE 502 may be further configured to determine the UE actions further based on one or more UE criteria such as, without limitation, UE performance, UE battery state, measurements of the associated physical cell, and measurements of one or more physical cells indicated by the potential disaster information.

At the same time, or at a later time, the network may determine to send an imminent disaster message to UEs in a geographical area affected by the disaster. The network may make such determination based in part on the potential disaster information. It may also make such determination based on further received information, which may be information of types and sources similar to that described above in relation to the potential disaster information. By way of non-limiting example, the network may receive meteorological information confirming the likelihood of occurrence of the disaster condition in the geographical area within a specified time. The network may also receive meteorological information indicating a greater likelihood of occurrence of the disaster condition in the geographical area, or a likelihood of occurrence of the disaster condition in a shorter timeframe. Any at all configurations and methods in this regard are contemplated and possible.

Thus, at 518 and 610, the associated RAN node 504 may generate an imminent disaster message indicating imminent occurrence of the disaster and the risk type of the disaster. The imminent disaster message may comprise imminent disaster information. The imminent disaster information may include one or more of: imminent disaster time prediction information indicating a predicted time of imminent occurrence of the disaster; and for each of one or more physical cells a risk of disruption of service by the physical cell based on the imminent occurrence of the disaster. Again, the RAN node 504 may receive or obtain the imminent disaster information, and generate the imminent disaster message, based on information received from any part of the communication network 104 or data network 102, and may include the same or similar sources, or the same or similar types of information, as involved in the generation of the potential disaster message. Such information may indicate, for example, that one or more disaster risk types indicated in the potential disaster information now have an increased likelihood of occurrence, disruption, or proximity in time. At 520 and 612, the associated RAN node 504 may broadcast the imminent disaster message, which may be in a geographical area containing the UE 502. Optionally, at 522 and 614, the associated RAN node 504 may also communicate the imminent disaster message to a neighbour RAN node 505, such as one or more of RAN nodes 212,214,216.

At 524 and 708, the UE 502 may receive the potential disaster message, which may be by broadcast. Optionally, at 526 and 710, the UE 502 may store the imminent disaster information, in whole or in part, in any suitable form or data storage. At 538 and 712, the UE 502 may determine a selected UE action based on a current UE state of the UE, an associated physical cell of the UE, and the potential disaster information. The UE 502 may further determine the selected UE action based on the imminent disaster information. For example, where UE 502 generated a UE actions index as described above, the UE 502 may determine the selected UE action type of the selected UE action based on the current UE state of the UE, the associated physical cell, the imminent disaster information, and the UE actions index. Determining the selected UE action type may include performing a lookup in the UE actions index based on the current UE state of the UE, the risk type of the disaster, and the risk score of the associated physical cell. By way of non-limiting example, where the UE actions index generated by the UE 502 is or includes the UE actions table, such as that shown in Table 1, the disaster risk type is ‘Tornado’, a risk score of the associated physical cell is 4-High, and the UE state of the UE 502 is RRC Idle, then the UE 502 may determine the selected UE action type to be Cell Reselection, as shown in Table 1. Alternatives are possible and contemplated.

At 530 and 714, the UE 502 may then perform the selected UE action. The particular actions performed by the UE 502 with respect to any particular selected UE action will depend on the selected UE action type, and may depend on other information available to the UE 502, such as one or more of the current UE state of the UE, the associated physical cell, the potential disaster information, and the imminent disaster information. Based on such information, the UE 502 may be configured to determine the selected UE action based on any predefined criteria, which may include one or more of: time to associate to another physical cell, UE performance, UE battery state, measurements of the associated physical cell, measurements of one or more physical cells indicated by the potential disaster information, and measurements of one or more physical cells indicated by the imminent disaster information. The UE action types may include at least one of conditional handover of the UE to another physical cell, cell redirection to another physical cell, cell reselection to another physical cell, and WiFi offloading to a WiFi access point. Where the UE determines to transition association to another physical cells, it may select one of the recommended physical cells indicated by the recommended wireless network association information, or one of the preferred physical cells indicated by the preferred physical cells information. Where the UE determines to transition association to a WiFi access point (or, WiFi offloading), it may select the access point from the recommended access points for wireless network association indicated by the recommended wireless network association information. Alternatives are possible and contemplated.

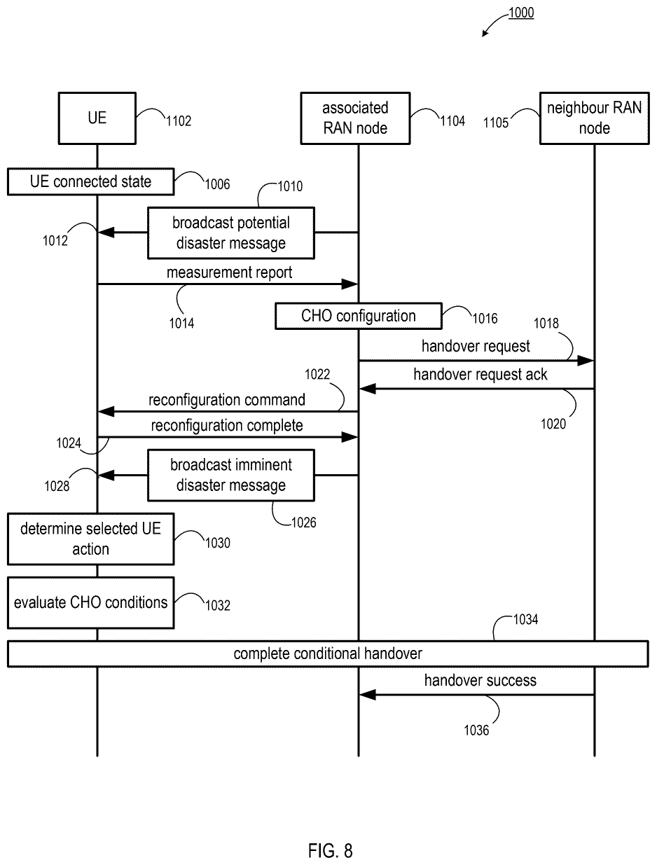

For example, FIG. 8 shows a timing diagram showing a method 1000 where the selected UE action type is a conditional handover. The UE 1002, associated RAN node 1004, and neighbour RAN node 1005 may be or may be similar to UE 502, associated RAN node 504, and neighbour RAN node 505. As shown at 1006, the UE state of the UE 1002 may be connected, which may be an RRC Connected state. At 1010, the associated RAN node 1004 may broadcast a potential disaster message. This may be or be similar to 510 and 606 as shown and described above. At 1012, the UE 1002 may receive the potential disaster message, which may be or be similar to 512 shown and described above. At 1014, the UE 1002 may generate and transmit a measurement report to associated RAN node 1004. At 1016, the associated RAN node 1004 may then determine a conditional handover (CHO) configuration, and at 1018 the RAN node 1004 may communicate a handover request to the neighbour RAN node 1005, which at 1020 may communicate a handover request acknowledgement to the associated RAN node 1004. At 1022, the associated RAN node 1004 may then communicate a reconfiguration command to the UE 1002, which may then perform the reconfiguration, and at 1024 may communicate a reconfiguration complete message to the associated RAN node 1004. At 1026, the associated RAN node 1004 may broadcast an imminent disaster message, which may be or be similar to 520 and 612 as shown and described above. At 1028, the UE 1002 may receive the imminent disaster message, which may be or be similar to 524 and 708 shown and described above. At 1030, the UE 1002 may determine the selected UE action, which may be or be similar to 528 and 712 shown and described above. In particular, the UE 1002 may determine the selected UE action type to be CHO, as shown and described above. At 1032, the UE 1002 may evaluate the CHO conditions. Based on such evaluation, at 1034 the UE 1002 may complete the conditional handover to the neighbour RAN node 1005. At 1036, the neighbour RAN node 1005 may transmit, and the associated RAN node 1004 may receive, a handover success message. One or more of 1032-1036 may be or be part of 530 and 714.

Where a UE is in a connected state, such as the RRC Connected state, the UE may instead determine as the selected UE action type a redirection to one of the recommended physical cells indicated by the recommended wireless network association information or one of the preferred cells indicated by the preferred physical cells information. Where there is more than one preferred cell, then the UE may be configured to select amongst them based on any suitable parameters, which may include, for example, the respective risks of disruption of service by the preferred physical cells indicated by the preferred physical cells information.

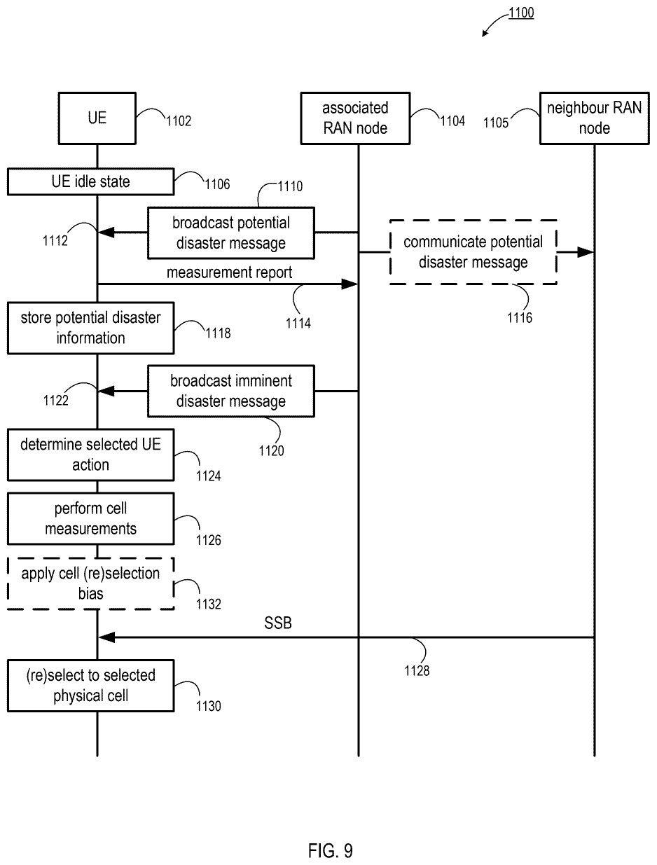

FIG. 9 shows another timing diagram showing a method 1100 where the selected UE action type is a cell reselection. The UE 1102, associated RAN node 1104, and neighbour RAN node 1105 may be or may be similar to UE 502, associated RAN node 504, and neighbour RAN node 505. As shown at 1106, the UE state of the UE 1102 may idle, or camping on the associated RAN node 1004, which may be an RRC Idle state. At 1110, the associated RAN node 1104 may broadcast a potential disaster message. This may be or be similar to 510 and 606 as shown and described above. At 1112, the UE 1102 may receive the potential disaster message, which may be or be similar to 512 shown and described above. Optionally, at 1114, the associated RAN node 1104 may also communicate the potential disaster message to the neighbour RAN node 1105. This may be or be similar to 511 and 608. At 1116, the UE 1102 may generate and transmit a measurement report to associated RAN node 1104. At 1118, the UE 1102 may store the potential disaster information. This may be or be similar to 514 and 704. At 1120, the associated RAN node 1104 may broadcast the imminent disaster message, which may be in a geographical area containing the UE 1102. This may be or be similar to 520 and 612. At 1122, the UE 1102 may receive the imminent disaster message. This may be or be similar to 524 and 708. At 1124, the UE 1102 may determine a selected UE action. This may be or be similar to 528 and 712. In particular, the UE 1102 may determine the selected UE action type to be Cell Reselection, as shown and described above. At 1126, the UE 1102 may perform cell measurements. At 1128, the UE 1102 may then receive from the neighbour RAN node 1105 a signal synchronization block (SSB). At 1130, the UE 1102 may select or reselect, as the case may be, to a selected physical cell controlled by the neighbour RAN node 1105. Optionally, prior to 1128, UE 1102 may be configured to apply a cell selection bias to one or more of the recommended physical cells indicated by the recommended wireless network association information or one or more of the preferred physical cells indicated by the preferred physical cells. In other words, the UE 1102 may be configured to bias, or prefer, (re) selection of one of the recommended or preferred cells specified by the potential disaster information. Any suitable biasing method may be employed. For example, 3GPP TS 38.304 (V18.4.0) describes a Qoffsettemp offset which may be used for cell (re) selection. The UE 1102 may be configured to do so based on any suitable predefined rules, which may be based on any suitable parameters, such as physical cell signal quality or strength measures, energy efficiency metrics, or predicted time of (re) association calculations.

As shown and described above, a UE may generate a UE actions index based on a received potential disaster information and the associated physical cell to which the UE is associated. The UE actions index may index UE action types by UE states, risk types, and risk scores, and in some embodiments may be or include a UE actions table. A non-limiting example of a UE actions table is shown above in Table 1. As may be seen in Table 1, it is possible that in one or more instances, a UE actions index may indicate more than one UE action type for a given combination of risk type, risk score, and UE state. Continuing the non-limiting example, in Table, for risk type “Tornado”, risk score “5-Critical”, and UE state “RRC Connected”, the Table indicates two alternative UE action types, namely conditional handover CHO and redirection. The UE may be further configured to select from amongst these alternative UE action types based on one or more UE criteria, which may be measured or otherwise determined by the UE, and optionally also based on predefined rules preconfigured into the UE or provided by the network. Thus, 528 and 712 may further include the UE 502 determining one or more UE criteria, which may relate to one or more of UE criteria relate to one or more of UE performance, UE battery state, measurements of the associated physical cell, measurements of one or more physical cells indicated by the potential disaster information, and measurements of one or more physical cells indicated by the imminent disaster information. Then, 528 and 712 may further include the UE 502 selecting the selected UE action type based at least in part on at least one of the determined UE criteria. Continuing the non-limiting example, as a result of this process, and as illustrated by the “(P)” in the discussed cell of Table 1, the UE 502 may determine to select conditional handover (CHO) over redirection in the conditions described above.

Alternatively, or additionally, the UE may be configured to prompt a user of the UE of the receipt of the potential disaster message, which indicates a potential occurrence of a disaster which may disrupt the physical cell to which the UE is associated, and thus disrupt connectivity to the UE. The UE may be configured to display information regarding the potential disaster risk, and may further be configured to receive input via a user interface of an indication by the user of an impression of risk visible to or otherwise available to the user, thereby providing the UE, and optionally also the network, with further information useful to perform the methods described herein. Thus, 528 and 712 may further include the UE 502, at any point after 512, receiving the potential disaster message in method 500, of displaying on a display of the UE a prompt indicating a risk of disruption of service by the associated physical cell based on the potential occurrence of the disaster. The UE may also be configured to receive a user input from a user interface of the UE, and to determine the selected UE action at least in part based on the user input.

As illustrated in Table 1, the UE 502 may be configured to generate the UE actions index to perform one or more actions given a combination of disaster risk type, risk score, and UE state. Table 1 shows columns labelled “Other” to indicate that the UE 502 may be configured, either by the UE manufacturer, operator, or network, with one or more alternative UE action types, to enable reconfiguration and expansion of the UE action types available. It is further contemplated that, as illustrated in Table 1, in a given combination of the discussed parameters, the UE 502 may be configured to select as the UE action type “Deferred”, meaning that the UE performs no particular UE action responsive to the potential disaster message or imminent disaster message. The UE 502 may determine to do so, for example, when the risk score or scores related to the corresponding disaster risk type are low, or below some predefined threshold. For example, as shown in Table 1, the UE 502 may be configured to defer action when the risk type is “Tornado” or “Flooding”, the risk score is “3-Medium”, and the UE state is “RRCE Connected”. The UE 502 may be configured in such case to defer action until receipt of a further potential disaster message or imminent disaster message providing updated information regarding its associated physical cell and the neighbouring RAN nodes. Moreover, in embodiments where the UE 502 is configured to prompt a user for input, as described above, the UE may be configured to enable the user, via the user interface, to select deferral of action, which the user may choose to do given circumstances known to the user, but not the UE, the associated RAN node, or the network.

The potential disaster message and the imminent disaster message may take any suitable form and may be broadcast and communicated in any suitable way and by any suitable means to perform the functions described herein. In some embodiments, the potential disaster message and the imminent disaster message are or are included in one or more system information block (SIB) 15 messages. In some embodiments, the potential disaster information is defined as a Network Assistance Information for Disaster (NAID) list NAIDInfoList-r21 of a SIB15 message, whereas the imminent disaster information is defined as a Network Indication for Disaster (NID) list NIDInfoList-r21 of a SIB15 message. A non-limiting example of a SIB15 specification including the NAID segment and the NID segment is as follows:

-- TAG-SIB15-START

| SIB15-r21 ::= | SEQUENCE { | |
|---|---|---|
| commonPLMNsWithDisasterCondition-r21 | SEQUENCE (SIZE (1..maxPLMN)) OF PLMN-Identity | OPTIONAL, -- |

Need R

| | |
|---|---|
| applicableDisasterInfoList-r21 | SEQUENCE (SIZE (1..maxPLMN)) OF ApplicableDisasterInfo-r17 |

OPTIONAL, -- Need R

| | | |
|---|---|---|
| lateNonCriticalExtension | OCTET STRING | OPTIONAL, |

...
}

| | |
|---|---|
| ApplicableDisasterInfo-r21 | ::= CHOICE { |
| noDisasterRoaming-r21 | NULL, |
| disasterRelatedIndication-r21 | NULL, |
| commonPLMNs-r21 | NULL, |
| dedicatedPLMNs-r21 | SEQUENCE (SIZE (1..maxPLMN)) OF PLMN-Identity |

}

| | |
|---|---|
| NAIDInfoList-r21 | SEQUENCE { (SIZE (1..max)) OF NAIDInfo-r21 OPTIONAL, -- Need R} |
| NIDInfoList-r21 | SEQUENCE (SIZE (1..max)) OF NIDInfo-r21 OPTIONAL, -- Need R, |
| NID | ENUMERATED {true} OPTIONAL |
| NAIDInfo-r21 | ::= SEQUENCE { |
| applicableUEactionsInfoList-r21 | SEQUENCE (SIZE (1..max#ofActions)) OF |

UEactionsInfo-r21

| | |
|---|---|
| | OPTIONAL, -- Need |
| | R |
| CellDisasterIndicationList-r21 | SEQUENCE (SIZE (1..max)) OF |

CellDisasterIndication-r21

| | |
|---|---|
| | OPTIONAL, -- Need |
| | R, |
| PreferredCellsInfoList-r21 | SEQUENCE (SIZE (1..max)) OF PreferredCellsInfo-r21 |
| | OPTIONAL, -- Need |
| | R, |

}

| | |
|---|---|
| UEactionsInfo-r21 | ::= SEQUENCE { |
| ConditionalHO | physCellId |
| CellRedirection | physCellId |
| CellReselection | physCellId |
| WIFI-Offloading | WIFI-ID |

}

| | |
|---|---|
| CellDisasterIndication-r21 | ::= SEQUENCE { |
| Cellid | physCellId |
| RiskScore | INTEGER(0..5) |
| RiskType | ENUMERATED {TORNADO, EARTHQUAKE, TSUNAMI, FLOODING, ..} |
| TRiskPrediction | AbsoluteTimeInfo-r21 |
| PreferredCellsInfo-r21 | ::= SEQUENCE { |
| Cellid | physCellId |
| RiskScore | INTEGER(0..5) |
| NWType | ENUMERATED {TN,NTN,WIFI,..} |
| RiskType | ENUMERATED {TORNADO, EARTHQUAKE, TSUNAMI, FLOODING, ..} |
| NIDInfo-r21 | ::= SEQUENCE { |
| Cellid | physCellId |
| RiskType | ENUMERATED {TORNADO, EARTHQUAKE, TSUNAMI, FLOODING, ..} |
| NearTRisk | AbsoluteTimeInfo-r21 |
| RiskScore | INTEGER(0..5) |

}
-- TAG-SIB15-STOP

The applicableUEactionsInfoList-r21 may include one or more UEactionsInfo-r21 records. The applicableUEactionsInfoList-r21 may have a UEactionsInfo-r21 record for each of a number of corresponding networks, which may be public land mobile networks (PLMNs). Each UEactionsInfo-r21 record may include a number of entries indicating for each of one or more wireless network association transition types respectively corresponding recommended physical cells or access points for wireless network association. For example, the UEactionsInfo-r21 record may include the following entries: ConditionalHO; CellRedirection; CellReselection; and WIFI-Offloading. The entries may have values physCellId or WIFI-ID indicating respectively corresponding recommended physical cells or WiFi access points for wireless network association in the event that the UE determines to perform that when performing that wireless network association transition type, as further described below.

The CellDisasterIndicationList-r21 may include one or more CellDisasterIndication-r21 records. Each CellDisasterIndication-r21 record may indicate for a corresponding physical cell a risk of disruption of service by the physical cell based on the potential occurrence of a given disaster type. For example, the CellDisasterIndication-r21 record may include: a Cellid entry having a physCellId value indicating the corresponding physical cell; a RiskScore entry having a INTEGER (0.5) value indicating a risk of disruption of service by the physical cell for a given disaster risk type; a RiskType entry having a ENUMERATED {TORNADO, EARTHQUAKE, TSUNAMI, FLOODING, . . . } value indicating the disaster risk type; and a TriskPrediction entry having a AbsoluteTimeInfo-r21 value indicating a predicted time of potential occurrence of the disaster. The CellDisasterIndicationList-r21 may include a CellDisasterIndication-r21 record for one or more physical cells within a geographical area, or controlled by one or more RAN nodes, such as RAN nodes 210,212,214,216, and for one or more risk types.

The PreferredCellsInfoList-r21 may include one or more PreferredCellsInfo-r21 records. Each PreferredCellsInfo-r21 record may indicate for a corresponding preferred physical cell a risk of disruption of service by the preferred physical cell based on the potential occurrence of a given disaster type. For example, the PreferredCellsInfo-r21 record may include: a Cellid entry having a physCellId value indicating the corresponding preferred physical cell; a RiskScore entry having a INTEGER (0 . . . 5) value indicating a risk of disruption of service by the preferred physical cell for a given disaster risk type; a NWType entry having a ENUMERATED {TN, NTN, WIFI, . . . } value indicating a network type of the preferred physical cell; and a RiskType entry having a ENUMERATED {TORNADO, EARTHQUAKE, TSUNAMI, FLOODING, . . . } value indicating the disaster risk type. The PreferredCellsInfoList-r21 may indicate physical cells recommended by the network for association by UEs in the event that they determine to reassociate to a different physical cell. The network may make such determination based on any suitable and relevant factors, including factors indicating that the preferred physical cells are safe from, have low likelihood of, or are comparatively less likely to experience, disruption from the occurrence of a particular risk type.

The NIDInfoList-r21 may include one or more NIDInfo-r21 records. Each NIDInfo-r21 record may indicate a predicted time of imminent occurrence of the disaster, and for each of one or more physical cells a risk of disruption of service by the physical cell based on the imminent occurrence of the disaster. For example, the NIDInfo-r21 record may include: a Cellid entry having a physCellId value indicating the corresponding physical cell; a RiskType entry having a ENUMERATED {TORNADO, EARTHQUAKE, TSUNAMI, FLOODING, . . . } value indicating the disaster risk type; a NearTRisk entry having a AbsoluteTimeInfo-r21 value indicating a predicted time of imminent occurrence of the disaster; and a RiskScore entry having a INTEGER (0.5) value indicating a risk of disruption of service by the physical cell for a given disaster risk type. The NIDInfoList-r21 may include a NIDInfo-r21 record for one or more physical cells within a geographical area, or controlled by one or more RAN nodes, such as RAN nodes 210,212,214,216, and for one or more risk types.

The SIB15 message may contain a indication, which may be termed a NID indication, indicating that the SIB15 message is or includes NIDInfoList-r21. When such SIB15 message-constituting an embodiment of the imminent disaster message described herein-is broadcast and received by UEs, the NID indication may indicate a recommendation by the network for the UEs to determine a selected UE action, as described herein.

In some embodiments, the associated RAN node 504 generates and broadcasts the potential disaster message, and then later generates and broadcasts the imminent disaster message. This may be done when the network determines, first, that the risk of occurrence of a certain disaster risk type is not imminent, but only potential, and that while UEs should not necessarily change their cell associations now, they should configure their respective UE action indexes now so as to be readily to perform appropriate UE actions quickly if and when the potential risk becomes imminent. In such case, therefore, the network may generate and broadcast the imminent disaster message once it becomes apparent, based on the determinations from externally provided information as described above, that the potential risk has indeed become imminent. Where SIB15 messages are used, the potential disaster message may be or be included in a first SIB15 message, while the imminent disaster message may be or be included in a second SIB15 message. Doing so enables the second SIB15 message to be smaller in size that the first SIB15 message, providing the advantage that when the disaster becomes imminent and it is desirable to broadcast the imminent disaster message, the risk of network congestion may be avoided or reduced, and greater energy efficiency may be achieved. Alternatively, in some embodiments, the RAN node 504 generates and broadcasts a single message containing both the potential disaster information and the imminent disaster information. In such case, the combined message may include a indication, such as the NID indication mentioned above, indicating that it constitutes an imminent disaster message-that is, that the network indicates an imminent risk. In such case, when SIB15 messages are used, the combined message may be or be included in a single, combined SIB15 message. Such alternative approach may be advantageous when for any reason the network was not able to determine the potential disaster risk a greater time in advance, and when it became able to do so the disaster was already imminent. In such case, the foregoing approach nevertheless provides for broadcast to the UEs configuration information as soon as possible to enable reassociation to other physical cells or access points before actual occurrence of the disaster.

### Non-Limiting Example Embodiments

The following are non-limiting example embodiments of the subject-matter disclosed herein.

Embodiment 1. A user equipment (UE) comprising: at least one processor; and at least one memory storing instructions that, when executed by the at least one processor, cause the UE to perform operations, the operations comprising: receiving a potential disaster message indicating potential occurrence of a disaster and comprising potential disaster information comprising: risk type information indicating a risk type of the disaster; physical cell risk information indicating for one or more physical cells a risk of disruption of service provided by the physical cell based on the potential occurrence of the disaster; recommended wireless network association information indicating for each of one or more wireless network association transition types respectively corresponding recommended physical cells or access points for wireless network association; and preferred physical cells information indicating for each of one or more preferred physical cells a risk of disruption of service provided by the preferred physical cell based on the potential occurrence of the disaster; generating a UE actions index based on the potential disaster information and an associated physical cell of the UE, wherein the UE is associated with the associated physical cell, the UE actions index indexing UE action types by UE states, risk types, and risk scores; determining a selected UE action based on a current UE state of the UE, the associated physical cell of the UE, and the UE actions index; and performing the selected UE action.

Embodiment 2. The UE of Embodiment 1, wherein: the potential disaster information further comprises potential disaster time prediction information indicating a predicted time of potential occurrence of the disaster.

Embodiment 3. The UE of Embodiment 1 or 2, wherein: the potential disaster information further comprises an imminent disaster indication indicating an imminent occurrence of the disaster.

Embodiment 4. The UE of any one of Embodiments 1 to 3, wherein: the potential disaster message is or is included in a system information block (SIB) 15 message.

Embodiment 5. The UE of Embodiment 1 or 2, wherein the operations further comprise: receiving an imminent disaster message indicating imminent occurrence of the disaster and the risk type of the disaster; and performing the selected UE action responsive to the imminent disaster message.

Embodiment 6. The UE of Embodiment 5, wherein: the imminent disaster message comprises imminent disaster information comprising: imminent disaster time prediction information indicating a predicted time of imminent occurrence of the disaster; and for each of one or more physical cells indication of a risk of disruption of service provided by the physical cell based on the imminent occurrence of the disaster; and determining the selected UE action comprises determining the selected UE action further based on the imminent disaster information.

Embodiment 7. The UE of Embodiment 6, wherein: determining the selected UE action comprises determining a selected UE action type of the selected UE action comprising: determining a risk score of the associated physical cell based on the imminent disaster information; and performing a lookup in the UE actions index based on the current UE state of the UE, the risk type of the disaster, and the risk score of the associated physical cell.

Embodiment 8. The UE of Embodiment 7, wherein: for at least one combination of the UE states, the risk types, and the risk scores, the UE actions index indexes a plurality of alternative UE action types; the lookup returns the plurality of alternative UE action types; and the operations further comprise: selecting the selected UE action type from the alternative UE action types.

Embodiment 9. The UE of Embodiment 8, wherein: selecting the selected UE action type from the alternative UE action types comprises: determining one or more UE criteria; and selecting the selected UE action type based in part on at least one of the one or more UE criteria.

Embodiment 10. The UE of Embodiment 9, wherein: the UE criteria relate to at least one of UE performance, UE battery state, measurements of the associated physical cell, measurements of one or more physical cells indicated by the potential disaster information, and measurements of one or more physical cells indicated by the imminent disaster information.

Embodiment 11. The UE of any one of Embodiments 5 to 10, wherein the operations comprise: receiving the imminent disaster message after receiving the potential disaster message.

Embodiment 12. The UE of Embodiment 11, wherein: the potential disaster message is or is included in a first system information block (SIB) 15 message, and the imminent disaster message is or is included in a second SIB15 message.

Embodiment 13. The UE of any one of Embodiments 1 to 12, wherein: the wireless network association transition types comprise at least one of conditional handover, cell redirection, cell reselection, and WiFi offloading.

Embodiment 14. The UE of any one of Embodiments 1 to 12, wherein: the current UE state is RRC Connected; and the selected UE action is a conditional handover of the UE to a selected physical cell.

Embodiment 15. The UE of any one of Embodiments 1 to 12, wherein: the current UE state is RRC Connected; and the selected UE action is a triggering redirection of the UE to a selected physical cell.

Embodiment 16. The UE of any one of Embodiments 1 to 12, wherein: the current UE state is RRC Idle or RRC Inactive; and the selected UE action is a cell reselection to a selected physical cell.

Embodiment 17. The UE of any one of Embodiments 1 to 12, wherein: the current UE state is RRC Idle or RRC Inactive; and the selected UE action is camping bias offset to preferentially select or reselect a selected physical cell.

Embodiment 18. The UE of Embodiment 11 or 12, wherein: the current UE state is RRC Connected; the selected UE action is a conditional handover of the UE to a selected physical cell; and the operations comprise: after receiving the potential disaster message and before receiving the imminent disaster message: receiving a reconfiguration message from the associated physical cell, the reconfiguration message indicating the selected physical cell; and after receiving the imminent disaster message: completing the conditional handover of the UE to the selected physical cell.

Embodiment 19. The UE of any one of Embodiments 14 to 18, wherein the operations comprise: selecting the selected physical cell from the recommended physical cells for wireless network association indicated by the recommended wireless network association information.

Embodiment 20. The UE of any one of Embodiments 14 to 18, wherein the operations comprise: selecting the selected physical cell from the preferred physical cells indicated by the preferred physical cells information.

Embodiment 21. The UE of any one of Embodiments 1 to 13, wherein: the selected UE action is WiFi offloading of the UE to a selected access point.

Embodiment 22. The UE of Embodiment 21, wherein the operations comprise: selecting the selected access point from the recommended access points for wireless network association indicated by the recommended wireless network association information.

Embodiment 23. The UE of any one of Embodiments 1 to 22, wherein: determining the selected UE action further comprises: displaying on a display of the UE a prompt indicating one or more of the risk types and one or more of the risk scores corresponding to the associated physical cell; receiving a user input from a user interface of the UE; determining the selected UE action in part based on the user input.

Embodiment 24. The UE of any one of Embodiments 1 to 23, wherein: the disaster type is one of a plurality of disaster types comprising at least one of tornado, earthquake, tsunami, drought, fire, flood, and wind.

Embodiment 25. A method for a user equipment (UE), the method comprising the operations of any one of Embodiments 1 to 24.

Embodiment 26. A non-transitory computer-readable medium comprising instructions stored thereon that, when executed by at least one processor of a user equipment (UE), cause the UE to perform the operations of any one of Embodiments 1 to 24.

Embodiment 27. A computer program comprising instructions, wherein the computer program when executed by at least one processor of a user equipment (UE), causes the UE to perform the operations of any one of Embodiments 1 to 24.

(Embodiment 28. Any of the Embodiments 1 to 27 wherein for at least one combination of the UE states, the risk types, and the risk scores, the UE actions index indexes a plurality of alternative UE action types.).

### Interpretation

The subject matter is described herein with reference to the accompanying drawings, in which example implementations are shown. However, many different example implementations may be used, and thus the description should not be construed as limited to the embodiments set forth herein. Rather, these example implementations are provided so that this application will be thorough and complete. Wherever possible, the same reference numbers are used in the drawings and the following description to refer to the same elements, and prime notation is used to indicate similar elements, operations or steps in alternative example implementations. Separate boxes or illustrated separation of logical elements of illustrated systems and devices does not necessarily require physical separation of such logical elements, as communication between such logical elements may occur by way of messaging, function calls, shared memory space, and so on, without any such physical separation. As such, logical elements need not be implemented in physically or logically separated platforms, although such logical elements are illustrated separately for ease of explanation herein. Different devices may have different designs, such that although some devices implement some logical elements in hardware, other devices may implement such logical elements in a programmable processor with code obtained from a machine-readable medium. Lastly, elements referred to in the singular may be plural and vice versa, except wherein indicated otherwise either explicitly or inherently by context.

References in the present disclosure to “one implementation,” “an implementation,” “an example implementation,” and the like indicate that the implementation described may include a particular feature, structure, or characteristic, but it is not necessary that every implementation includes the particular feature, structure, or characteristic. Moreover, such phrases are not necessarily referring to the same implementation. Further, when a particular feature, structure, or characteristic is described in connection with an implementation, it is submitted that it is within the knowledge of one skilled in the art to effect such feature, structure, or characteristic in connection with other implementations whether or not explicitly described.

Through the descriptions of the preceding implementations, the subject matter disclosed may be implemented by using hardware only, or by using software and a necessary hardware platform, or by a combination of hardware and software. The coding of software for carrying out the above-described methods described is within the scope of a person of ordinary skill in the art having regard to the present disclosure. Based on such understandings, the technical solution of the subject matter disclosed herein may be embodied in the form of a software product. The software product may be stored in a non-volatile or non-transitory storage medium, which may be, for example, an optical storage medium, flash drive, a hard disk, a solid-state drive, a universal serial bus (USB) drive, etc. The software program or product (otherwise referred to as a computer program or computer product) includes instructions that enable a computing device (e.g., a user equipment or a core network apparatus as described herein) to execute the methods provided in the implementations of the present disclosure.

The operations (otherwise referred to as steps) of the methods shown in the flowcharts in the drawings and described herein are for purposes of illustration only. There may be many variations to these operations or steps without departing from the scope of the present disclosure. For instance, the operations may be performed in a differing order, or operations may be added, deleted, or modified, as appropriate.

As used in this application, the term “circuitry” may refer to one or more or all of the following: (a) hardware-only circuit implementations (such as implementations in analog circuitry, digital circuit, and/or quantum circuit); (b) combinations of hardware circuit(s) and software, such as: (i) a combination of analog, digital, and/or quantum hardware circuit(s); and (ii) any or all portions of hardware processor(s) with software (including digital signal and/or quantum processor(s)) with software, and memory(ies) that work together to cause an apparatus, such as a mobile phone device, computing device, a computing system, or server, to perform various operations); and (c) any or all portions of hardware circuit(s), such as microprocessor(s), processor(s) and/or quantum processor(s), that requires software (e.g., firmware) for operation, but the software may not be present when the software is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

All values and sub-ranges within disclosed ranges are also disclosed. Also, although the systems, devices and processes disclosed and shown herein may comprise a specific plurality of elements, the systems, devices and assemblies may be modified to comprise additional or fewer of such elements. Although several example implementations are described herein, modifications, adaptations, and other implementations are possible. For example, substitutions, additions, or modifications may be made to the elements illustrated in the drawings, and the example methods described herein may be modified by substituting, reordering, or adding steps to the disclosed methods.

It is anticipated that features from one or more of the above-described implementations may be selected to create alternate implementations comprised of a sub-combination of features which may not be explicitly described above. In addition, features from one or more of the above-described implementations may be selected and combined to create alternate implementations comprised of a combination of features which may not be explicitly described above. Features suitable for such combinations and sub-combinations would be readily apparent to persons skilled in the art upon review of the present disclosure as a whole.

In addition, numerous specific details are set forth to provide a thorough understanding of the example implementations described herein. It will, however, be understood by those of ordinary skill in the art that the example implementations described herein may be practiced without these specific details. Furthermore, well-known methods, procedures, and elements have not been described in detail so as not to obscure the example implementations described herein. The subject matter described herein and in the recited claims intends to cover and embrace all suitable changes in technology.

Although the subject matter disclosed herein and some of its advantages (e.g., technological improvements) have been described in detail, other advantages (e.g., other technological improvements) may be apparent from the present disclosure. It should be understood that various changes, substitutions and alterations can be made to the subject matter disclosed herein without departing from the scope of the present disclosure as defined by the appended claims.

The subject matter disclosed herein may be embodied or implemented in other specific forms without departing from the scope of the claims. The described example implementations are to be considered in all respects as being only illustrative and not restrictive. The subject matter disclosed herein intends to cover and embrace all suitable changes in technology. The scope of the present disclosure is, therefore, described by the appended claims rather than by the foregoing description. The scope of the claims should not be limited by the implementations set forth in the examples or implementations described herein but should be given the broadest interpretation consistent with the description as a whole.

1-27. (canceled)

28. A user equipment (UE) comprising:
at least one processor; and
at least one memory storing instructions that, when executed by the at least one processor, cause the UE to perform operations, the operations comprising:
receiving a potential disaster message indicating potential occurrence of a disaster and comprising potential disaster information comprising:
risk type information indicating a risk type of the disaster;
physical cell risk information indicating for one or more physical cells a risk of disruption of service provided by the physical cell based on the potential occurrence of the disaster;
recommended wireless network association information indicating for each of one or more wireless network association transition types respectively corresponding recommended physical cells or access points for wireless network association; and
preferred physical cells information indicating for each of one or more preferred physical cells a preferred physical cell risk score indicating a risk of disruption of service provided by the preferred physical cell based on the potential occurrence of the disaster;
generating a UE actions index based on the potential disaster information and an associated physical cell of the UE, wherein the UE is associated with the associated physical cell, the UE actions index indexing UE action types by UE states, risk types, and risk scores;
determining a selected UE action based on a current UE state of the UE, the associated physical cell of the UE, and the UE actions index; and
performing the selected UE action.

29. The UE of claim 28, wherein:
the potential disaster information further comprises an imminent disaster indication indicating an imminent occurrence of the disaster.

30. The UE of claim 28, wherein:
the potential disaster message is or is included in a system information block (SIB) 15 message.

31. The UE of claim 28, wherein the operations further comprise:
receiving an imminent disaster message indicating imminent occurrence of the disaster and comprising imminent disaster information comprising:
imminent disaster time prediction information indicating a predicted time of imminent occurrence of the disaster; and
for each of one or more physical cells indication of a risk of disruption of service provided by the physical cell based on the imminent occurrence of the disaster;
determining the selected UE action further based on the imminent disaster information.

32. The UE of claim 31, wherein:
for at least one combination of the UE states, the risk types, and the risk scores, the UE actions index indexes a plurality of alternative UE action types; and
determining the selected UE action comprises determining a selected UE action type of the selected UE action comprising:
determining a risk score of the associated physical cell based on the imminent disaster information; and
performing a lookup in the UE actions index based on the current UE state of the UE, the risk type of the disaster, and the risk score of the associated physical cell, wherein the lookup returns the plurality of alternative UE action types; and
selecting the selected UE action type from the alternative UE action types.

33. The UE of claim 32, wherein:
selecting the selected UE action type from the alternative UE action types comprises:
determining one or more UE criteria relating to at least one of UE performance, UE battery state, measurements of the associated physical cell, measurements of one or more physical cells indicated by the potential disaster information, and measurements of one or more physical cells indicated by the imminent disaster information; and
selecting the selected UE action type based in part on at least one of the one or more UE criteria.

34. The UE of claim 31, wherein the operations comprise:
receiving the imminent disaster message after receiving the potential disaster message.

35. The UE of claim 34, wherein:
the potential disaster message is or is included in a first system information block (SIB) 15 message, and the imminent disaster message is or is included in a second SIB15 message.

36. The UE of claim 28, wherein:
the current UE state is RRC Connected; and
the selected UE action is a conditional handover of the UE to a selected physical cell.

37. The UE of claim 28, wherein:
the current UE state is RRC Connected; and
the selected UE action is a triggering redirection of the UE to a selected physical cell.

38. The UE of claim 28, wherein:
the current UE state is RRC Idle or RRC Inactive; and
the selected UE action is a cell reselection to a selected physical cell.

39. The UE of claim 34, wherein:
the current UE state is RRC Connected;
the selected UE action is a conditional handover of the UE to a selected physical cell; and
the operations comprise:
after receiving the potential disaster message and before receiving the imminent disaster message:
receiving a reconfiguration message from the associated physical cell, the reconfiguration message indicating the selected physical cell; and
after receiving the imminent disaster message:
completing the conditional handover of the UE to the selected physical cell.

40. The UE of claim 36, wherein the operations comprise:
selecting the selected physical cell from the recommended physical cells for wireless network association indicated by the recommended wireless network association information.

41. The UE of claim 36, wherein the operations comprise:
selecting the selected physical cell from the preferred physical cells indicated by the preferred physical cells information.

42. The UE of claim 28, wherein:
the selected UE action is WiFi offloading of the UE to a selected access point.

43. The UE of claim 42, wherein the operations comprise:
selecting the selected access point from the recommended access points for wireless network association indicated by the recommended wireless network association information.

44. The UE of claim 28, wherein:
determining the selected UE action further comprises:
displaying on a display of the UE a prompt indicating one or more of the risk types and one or more of the risk scores corresponding to the associated physical cell;
receiving a user input from a user interface of the UE;
determining the selected UE action in part based on the user input.

45. The UE of claim 28, wherein:
the disaster type is one of a plurality of disaster types comprising at least one of tornado, earthquake, tsunami, drought, fire, flood, and wind.

46. A method for a user equipment (UE), the method comprising:
receiving a potential disaster message indicating potential occurrence of a disaster and comprising potential disaster information comprising:
risk type information indicating a risk type of the disaster;
physical cell risk information indicating for one or more physical cells a risk of disruption of service provided by the physical cell based on the potential occurrence of the disaster;
recommended wireless network association information indicating for each of one or more wireless network association transition types respectively corresponding recommended physical cells or access points for wireless network association; and
preferred physical cells information indicating for each of one or more preferred physical cells a preferred physical cell risk score indicating a risk of disruption of service provided by the preferred physical cell based on the potential occurrence of the disaster;
generating a UE actions index based on the potential disaster information and an associated physical cell of the UE, wherein the UE is associated with the associated physical cell, the UE actions index indexing UE action types by UE states, risk types, and risk scores;
determining a selected UE action based on a current UE state of the UE, the associated physical cell of the UE, and the UE actions index; and
performing the selected UE action.

47. A non-transitory computer-readable medium comprising instructions stored thereon that, when executed by at least one processor of a user equipment (UE), cause the UE to perform operations, the operations comprising:
receiving a potential disaster message indicating potential occurrence of a disaster and comprising potential disaster information comprising:
risk type information indicating a risk type of the disaster;
physical cell risk information indicating for one or more physical cells a risk of disruption of service provided by the physical cell based on the potential occurrence of the disaster;
recommended wireless network association information indicating for each of one or more wireless network association transition types respectively corresponding recommended physical cells or access points for wireless network association; and
preferred physical cells information indicating for each of one or more preferred physical cells a preferred physical cell risk score indicating a risk of disruption of service provided by the preferred physical cell based on the potential occurrence of the disaster;
generating a UE actions index based on the potential disaster information and an associated physical cell of the UE, wherein the UE is associated with the associated physical cell, the UE actions index indexing UE action types by UE states, risk types, and risk scores;
determining a selected UE action based on a current UE state of the UE, the associated physical cell of the UE, and the UE actions index; and
performing the selected UE action.
